(19) United States
(12) Patent Application Publication
(10) Pub. No.: US 2006/0265523 A1
(43) Pub. Date: Nov. 23, 2006

(54) Data transfer circuit and data transfer method

(76) Inventor: Kazuhiro Noshu, Odawara (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/170,151

(22) Filed: Jun. 30, 2005

(30) Foreign Application Priority Data
May 17, 2005 (JP) 2005-144720

(51) Int. Cl. G06F 13/28

(52) U.S. Cl. 710/22

(57) ABSTRACT

A data transfer circuit having: a fetch circuit for fetching, in one bus access, a plurality of data transfer parameters stored by a processor in a local memory to direct DMA transfer; a parameter storage memory for storing the data transfer parameters fetched by the fetch circuit; and a DMA transfer circuit for conducting DMA transfer based on the data transfer parameters stored in the parameter storage memory.

### CROSS-REFERENCE TO RELATED APPLICATION

This application relates to and claims priority from Japanese Patent Application No. 2005-144720, filed on May 17, 2005, the entire disclosure of which is incorporated herein by reference.

### BACKGROUND OF THE INVENTION

The present invention relates to a data transfer circuit and a data transfer method.

A method (hereinafter called the “sequential method”) where DMA(Direct Memory Access)transfer is conducted in a manner where a processor sets data transfer parameters (data transfer commands) in a local memory and then a data transfer circuit is started up to fetch the data transfer parameters set in the local memory has been know as one type of DMA transfer method. The sequential method can decrease overhead and increase the data transfer multiplicity compared to a method where DMA transfer is conducted in a manner where the processor directly sets data transfer parameters in the data transfer circuit and then the data transfer circuit conducts DMA transfer based on the data transfer parameters. This is because if the processor and the data transfer circuit are connected to each other using a PCI interface of a 4-byte width, for example, the processor has to access the data transfer circuit a number of times in order to set, in the data transfer circuit, 32 to 64-byte data transfer parameters, thereby causing overhead.

With the sequential method, even when the data transfer circuit is conducting DMA transfer, the processor can set data transfer parameters in the local memory at a timing which is convenient for itself, for example, at times when other task processing is not in progress. Moreover, because the data transfer parameters include chain bits indicating existence of subsequent data transfer parameters, the processor needs to start up the data transfer circuit only once to make it automatically fetch plural data transfer parameters from the local memory and conduct DMA transfer. Therefore, the processor need not access the data transfer circuit every time it executes a data transfer parameter, and it becomes possible to restrain generation of a PCI bus neck to some extent. Furthermore, because the data transfer circuit stores a status indicating DMA completion in the local memory when DMA transfer is complete, the processor can process the status at a timing which is convenient for itself. Japanese Patent Laid-Open (Kokai) Publication No. 2000-347988 is known as a reference describing a DMA transfer method.

### SUMMARY OF THE INVENTION

However, the sequential method causes a bus neck between the data transfer circuit and the local memory because the data transfer parameters are executed one by one sequentially, that is, the data transfer circuit fetches a data transfer parameter from the local memory, conducts DMA transfer, stores a status indicating DMA completion in the local memory, and then fetches another data transfer parameter from the local memory.

The present invention has been devised in the light of the above-described problems. It is an object of this invention to solve the generation of a bus neck between the data transfer circuit executing DMA transfer and the local memory storing data transfer parameters.

The data transfer circuit of this invention conducts DMA transfer between an input/output device and a memory. The input/output device is, for example, a device making data input/output requests (for example, a host computer) or another peripheral device. The memory is, for example, a cache memory. The data transfer circuit includes the following components: a fetch circuit fetching, in one bus access, a plurality of data transfer parameters stored by a processor in a local memory to direct DMA transfer; a parameter storage memory storing the data transfer parameters fetched by the fetch circuit; and a DMA transfer circuit conducting DMA transfer based on the data transfer parameters stored in the parameter storage memory. Because the plural data transfer parameters are fetched in one bus access, the problem of the generation of a bus neck between the data transfer circuit and the local memory can be solved.

For example, the parameter storage memory stores DMA transfer statuses for respective instructions of the plural data transfer parameters. The fetch circuit transfers the plural statuses from the parameter storage memory to the local memory in one bus access. The problem of the generation of a bus neck between the data transfer circuit and the local memory can be solved because the plural statuses are transferred to the local memory in one bus access.

Moreover, the parameter storage memory, for example, divides the data transfer parameters into write commands to store and read commands to store. The DMA transfer circuit executes parallel processing for the write commands and the read commands. Because the write commands and the read commands are executed at the same time, DMA transfer efficiency can be enhanced.

Furthermore, the DMA transfer circuit has: a first interface conducting DMA transfer from the input/output device to the memory; and a second interface conducting DMA transfer from the memory to the input/output device. Accordingly, DMA transfer from the input/output device to the memory and DMA transfer from the memory to the input/output device can be parallel-processed.

This invention makes it possible to solve the problem of generation of a bus neck between the data transfer circuit executing DMA transfer and the local memory storing data transfer parameters.

This and other objects, features and advantages of the present invention will become more apparent upon reading the following detailed description along with the attached drawings.

### BRIEF DESCRIPTION OF THE DRAWINGS

FIG. 1 is a hardware configuration diagram of a storage system according to Embodiment 1 of the present invention.

FIG. 2 is a hardware configuration diagram of a channel control unit according to Embodiment 1.

FIG. 3 is a hardware configuration diagram of a data transfer circuit according to Embodiment 1.

FIG. 4 shows a processing flow for DMA transfer according to Embodiment 1.

FIG. 5 is an explanatory drawing of a DMA cycle according to Embodiment 1.

FIG. 6 shows a processing flow for DMA transfer according to Embodiment 2 of the present invention.

FIG. 7 is an explanatory drawing of a DMA cycle according to Embodiment 2.

FIG. 8 is an explanatory drawing of bus arbitration executed at a buffer interface according to Embodiment 2.

FIG. 9 is a sequence chart for DMA transfer according to Embodiment 2.

### DETAILED DESCRIPTION OF THE INVENTION

Embodiments of the present invention are described below in detail with reference to the attached drawings. The respective embodiments do not limit the scope of the claims and all characteristics described in the embodiments are not necessarily indispensable as the solving means of the present invention.

### Embodiment 1

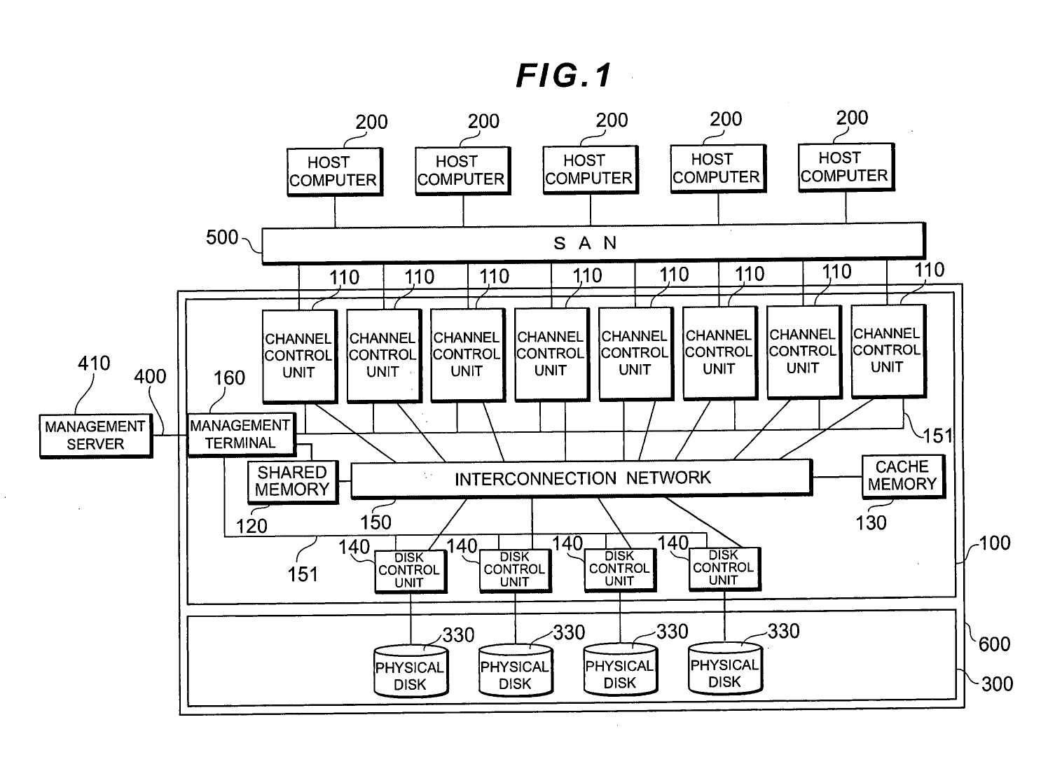

FIG. 1 shows a hardware configuration of a storage system 600 according to Embodiment 1 of the present invention. The storage system 600 is mainly composed of a disk controller 100 and a disk unit 300. The disk controller 100 controls, for example, input and output of data to and from the disk unit 300 according to commands received from host computers 200. It also executes various processing such as setting and changing of configuration information of the storage system 600 according to commands received from a management server 410.

The host computers 200 are, for example, host systems such as personal computers, work stations, or mainframe computers and those used in bank automated teller systems, flight seat reservation systems, or the like. The host computers 200 are connected to the disk controller 100 via a SAN 500 in a manner that enables communication. The SAN 500 is a network transmitting data between the host computers 200 and the disk controller 100 in blocks, which are the units for storage resources provided by the disk unit 300. The communication protocol used for communication between the host computers 200 and the disk controller 100 via the SAN 500 is, for example, Fibre Channel Protocol.

The host computers 200 and the disk controller 100 may not be necessarily connected via the SAN 500, but they may be connected via, for example, a Local Area Network (LAN), or may be directly connected without involving any network. If they are connected via a LAN, communication may be conducted according to Transmission Control Protocol/Internet Protocol (TCP/IP). On the contrary, if they are connected directly without involving a network, communication may be conducted according to communication protocols such as Fibre Connection (FICON; registered trademark), Enterprise System Connection (ESCON; registered trademark), Advanced Connection Architecture (ACONARC; registered trademark), and Fibre Connection Architecture (FIBARC; registered trademark).

The management server 410 is connected to a management terminal 160 via an external LAN 400. The external LAN 400 is configured with the Internet or a private line or the like. Communication between the management server 410 and the management terminal 160 via the external LAN 400 is conducted according to communication protocols such as TCP/IP.

The disk unit 300 has a plurality of physical disk drives 330. These physical disk drives 330 are hard disk drives such as Advanced Technology Attachment (ATA) disk drives, Small Computer System Interface (SCSI) disk drives, or Fibre Channel disk drives. The disk drives may be allocated in arrays and constitute RAID (Redundant Arrays of Inexpensive Disks) arrangement. The physical disk drives 330 provide physical storage areas, that is, physical volumes for which logical devices (LDEVs) may be set. The disk controller 100 and the disk unit 300 may be connected directly, or via a network. Alternatively, they may be integrated.

The disk controller 100 has channel control units 110, a shared memory 120, a cache memory 130, disk control units 140, the management terminal 160, and a interconnection network 150.

The disk controller 100 communicates with the host computers 200 via the SAN 500 by means of the channel control units 110. The channel control units 100 have communication interfaces for communication with the host controllers 200 and have the function of transmitting data input/output commands therebetween. Each of the channel control units 110 and the management terminal 160 are connected to one another via an internal LAN (a shared bus) 151. Accordingly, micro programs or similar to be executed by the channel control units 110 can be installed from the management terminal 160.

The interconnection network 150 connects the channel control units 110, the shared memory 120, the cache memory 130, the disk control units 140, and the management terminal 160 to one another. Transmission of data and commands therebetween is conducted via this interconnection network 150. The interconnection network 150 is configured with, for example, a crossbar switch or similar.

The shared memory 120 and the cache memory 130 are memory apparatuses shared between the channel control units 110 and the disk control units 140. The shared memory 120 is mainly used for storing resource configuration information and various commands. On the other hand, the cache memory 130 is mainly used for temporarily storing data read from and written to the physical disks drives 330.

For example, if a data input/output request a channel control unit 110 received from a host computer 200 is a write command, the channel control unit 110 writes the write command to the shared memory 120 and also writes the write target data received from the host computer 200 to the cache memory 130.

The disk control units 140 monitor the shared memory 120 at all times. When they detect that a write command has been written to the shared memory 120, the relevant disk control unit 140 reads dirty data from the cache memory 130 according to the command and destages it to the physical disk drives 330.

If a data input/output request a channel control unit 110 received from a host computer 200 is a read command, the channel control unit 110 checks whether or not read target data exists in the cache memory 130. If the read target data exists in the cache memory 130, the channel control unit 110 reads the data from the cache memory 130 and transmits it to the host computer 200.

If the read target data does not exist in the cache memory 130, the channel control unit 110 writes the read command to the shared memory 120. When the disk control units 140, always monitoring the shared memory 120, detect that the read command has been written to the shared memory 120, the relevant disk control unit 140 reads read target data from the disk unit 300, writes it to the cache memory 130, and writes to that effect to the shared memory 120. Then, the channel control unit 110 detects that the read target data has been written to the cache memory 130, reads it from the cache memory 130, and transmits it to the host computer 200.

In this manner, data transmission is conducted between the channel control units 110 and the disk control units 140 via the cache memory 130. Of data stored in the physical disk drives 330, data read/written by the channel control units 110 and the disk control units 140 is temporarily written in the cache memory 130.

Incidentally, in addition to a configuration where data write/read instructions are transmitted from the channel control units 110 to the disk control units 140 indirectly via the shared memory 120, a configuration where data write/read instructions are transmitted from the channel control units 110 to the disk control units 140 directly without involving the shared memory 120, may be applied. Alternatively, it is possible to make the channel control units 110 provide the functions of the disk control units 140 to control input and output of data.

The disk control units 140 are connected, in a manner that enables communication, to the data-storing physical disk drives 330 and control the disk unit 300. For example, as described above, they read and write data from and to the physical disk drives 330 according to data input/output requests received by the channel control units 110 from the host computers 200.

Each of the disk control units 140 and the management terminal 160 are connected to one another via the internal LAN 151 so that they can communicate with one another. Accordingly, micro programs or the like can be transmitted from the management terminal 160 and installed on the disk control units 140 to be executed.

The management terminal 160 is a computer managing the storage system 600. By operating the management terminal 160, a system administrator can make configuration settings for the physical disk drives 330 and settings for paths between the host computers 200 and the channel control units 140, and install micro programs for execution by the channel control units 110 and the disk control units 140. Configuration settings for the physical disk drives 330 refers to, for example, addition or subtraction of physical disk drives 330, as well as changes in the RAID configuration (for example, a change from RAID 1 to RAID 5). Moreover, by using the management terminal 160, the system administrator can also perform tasks such as checking the operational condition of the storage system 600, specifying faulty sites in the system, and installing operating systems or similar to be executed by the channel control units 110. These various setting and controlling tasks can be performed via a user interface in the management terminal 160.

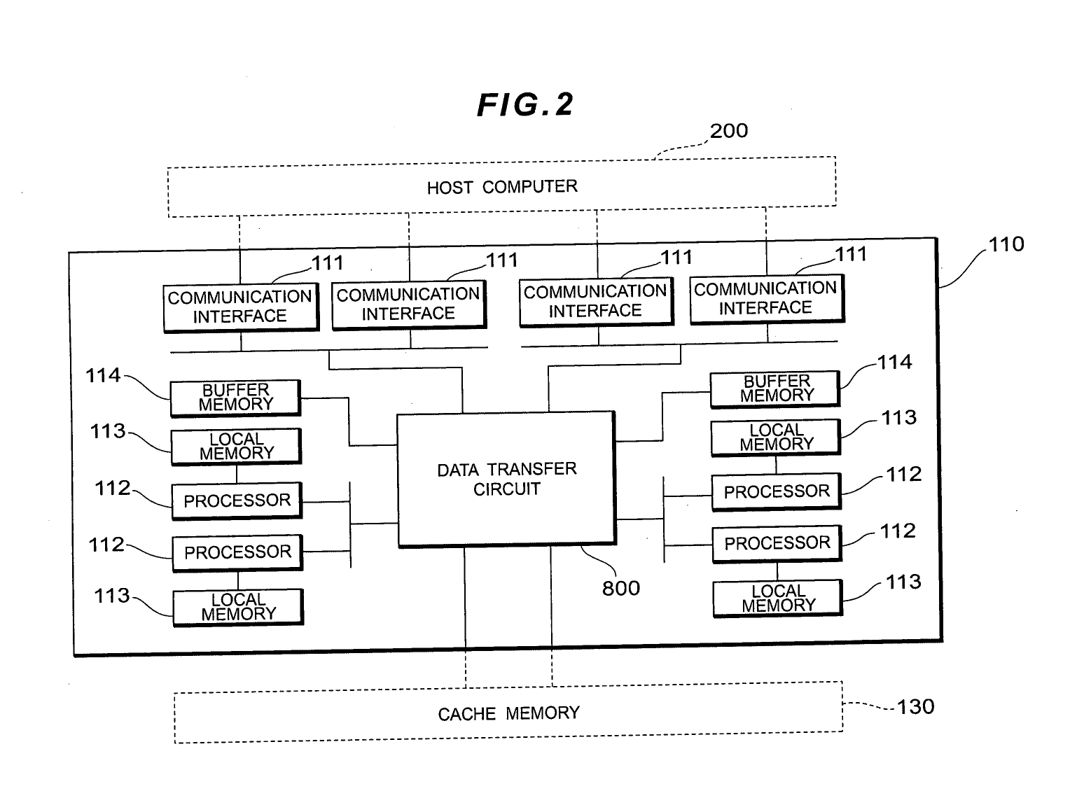

FIG. 2 shows a hardware configuration of a channel control unit 110. A channel control unit has communication interfaces 111, processors 112, local memories 113, buffer memories (data transfer external memories) 114, and a data transfer circuit 800.

The communication interfaces 111 include protocol controllers controlling protocols such as Fibre Channel Protocol or SCSI protocol, and control communication with a host computer 200. The communication interfaces 111 have the function of, for example, receiving block access requests from the host computer 200. A Network Attached Storage (NAS) function may be provided to the communication interfaces 111 so that they can receive file access requests from the host computer 200.

The processors 112 operate based on channel adapter firmware loaded in the local memories 113 and control, for example, DMA transfer between the host computer 200 and the cache memory 130. The local memories 113 serve as work areas for the processors 112 and store various control information (for example, data transfer parameters directing DMA transfer and statuses indicating DMA completion) necessary for DMA transfer. The buffer memories 114 temporarily store data DMA-transferred between the host computer 200 and the cache memory 130. The data transfer circuit 800 is connected to the communication interfaces 111, the processors 112, the buffer memories 114, and the cache memory 130 and executes DMA transfer between the host computer 200 and the cache memory 130.

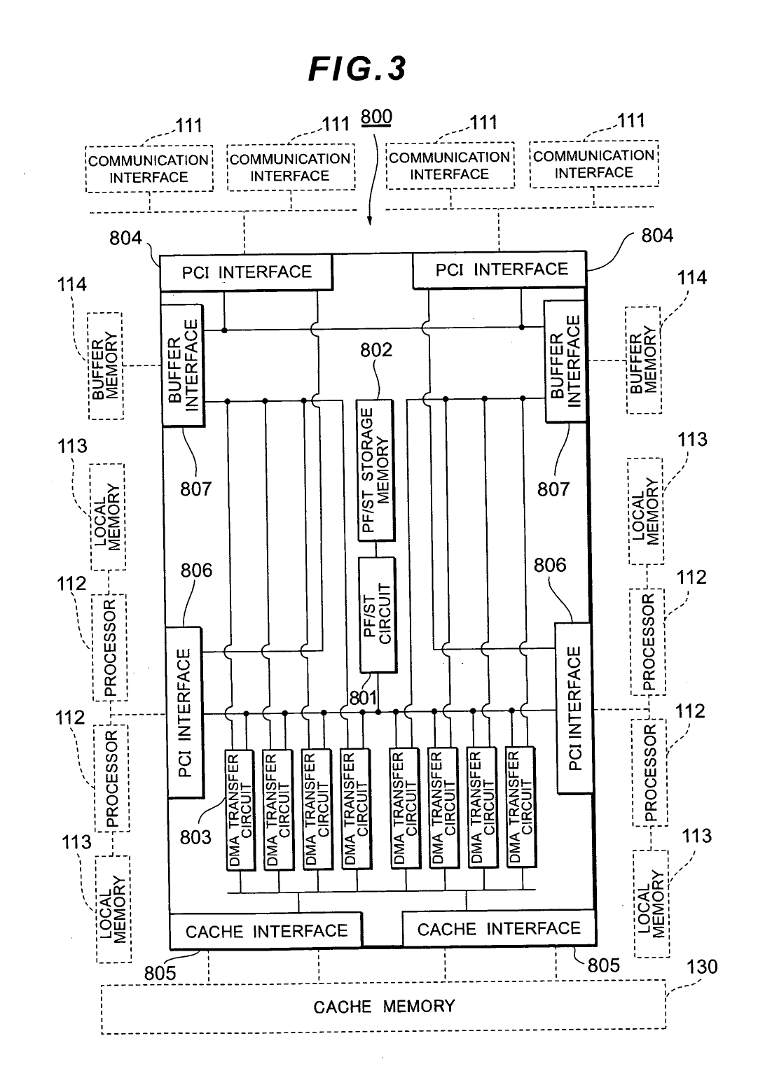

FIG. 3 shows a hardware configuration of a data transfer circuit 800. A data transfer circuit 800 has a PF(parameter fetch)/ST(status store) circuit 801, a PF/ST storage memory 802, DMA transfer circuits 803, PCI interfaces 804, cache interfaces 805, PCI interfaces 806, and buffer interfaces 807.

The PF/ST circuit 801 is connected via the PCI interfaces 806 to the processors 112 and the local memories 113 so that it can fetch data transfer parameters stored in the local memories 113 and store them in the PF/ST storage memory 802, and it can read statuses stored in the PF/ST storage memory 802 and transfer them to the local memories 113. The PF/ST storage memory 802 is connected to the PF/ST circuit 801 and stores data transfer parameters fetched by the PF/ST circuit 801 and statuses generated by the DMA transfer circuits 803. The DMA transfer circuits 803 are connected to the buffer memories 114 via the buffer interfaces 807 and to the cache memory 130 via the cache interfaces 805. They execute DMA transfer between a host computer 200 and the cache memory 130 via the buffer memories 114 on the basis of data transfer parameters stored in the PF/ST storage memory 802. When DMA transfer is complete, the DMA transfer circuits 803 generate a status and store it in the PF/ST storage memory 802. If the DMA transfer was conducted normally, the status includes DMA completion notification and if the DMA transfer was not conducted normally, it includes to information to that effect.

The PCI interfaces 804 connect the communication interfaces 111, the buffer interfaces 807, and the PCI interfaces 806 to one another and provide bus arbitration and the like for data transfer. The cache interfaces 805 connect the DMA transfer circuits 803 and the cache memory 130 to one another. The PCI interfaces 806 connect the DMA transfer circuits 803, the buffer interfaces 807, and the processors 112 to one another and provide bus arbitration and the like for data transfer. The buffer interfaces 807 connect the DMA transfer circuits 803, the PCI interfaces 804, and the buffer memories 114 to one another and provide bus arbitration for DMA transfer executed between the host computer 200 and the cache memory 130 via the buffer e memory 114.

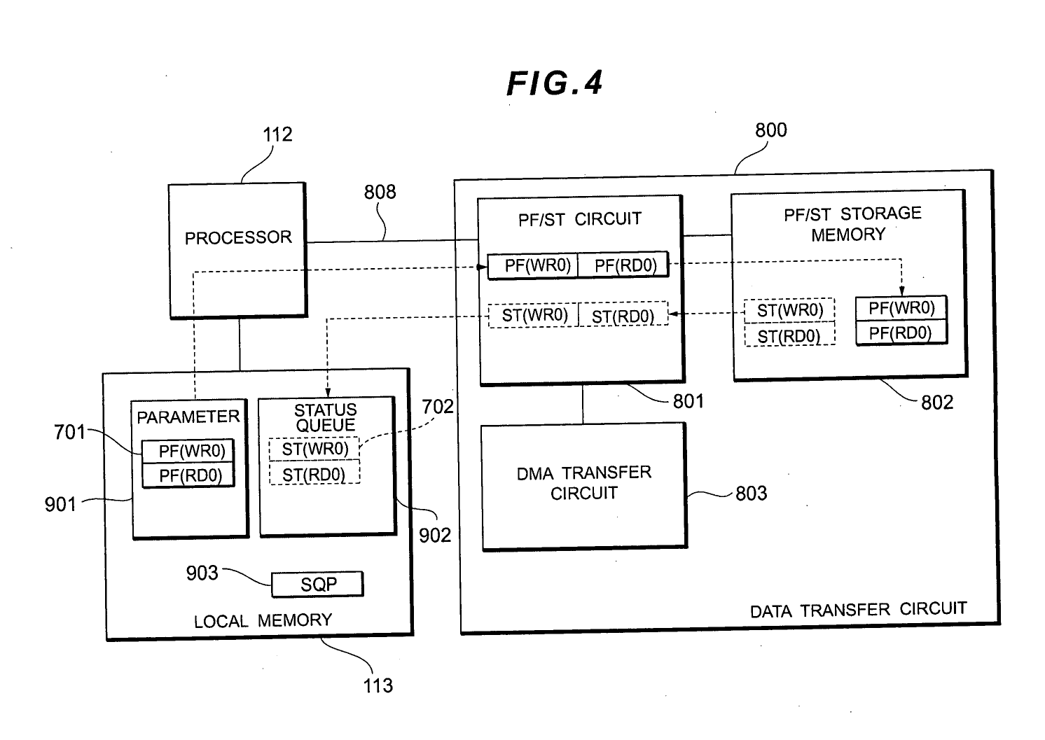

Next, the flow of the DMA transfer processing according to Embodiment 1 is explained below with reference to FIG. 4.

A local memory 113 has a parameter storage area 901 storing data transfer parameters 701; a status queue 902 storing statuses 702; and a status queue pointer 903 counting the number of statuses 702 stored in the status queue 902. A data transfer circuit 800 and a processor 112 are connected via a PCI bus 808.

In the DMA transfer preparatory stage, the processor 112 stores data transfer parameters 701 in the parameter storage area 901 in the local memory 113. Data transfer parameters 701 include write commands (WR) instructing DMA transfer from a host computer 200 to the cache memory 130, and read commands (RD) instructing DMA transfer from the cache memory 130 to the host computer 200. The processor 112 may set a plurality of data transfer parameters 701 at a time.

When setting of data transfer parameters 701 in the local memory 113 is complete, the processor 112 sends a start-up instruction to the data transfer circuit 800. Then, the PF/ST circuit 801 accesses the local memory 113 via the PCI bus 808 and fetches a plurality of data transfer parameters in one bus access. The fetched data transfer parameters 701 are stored in the PF/ST storage memory 802. A DMA transfer circuit 803 reads the data transfer parameters 701 stored in the PF/ST storage memory 802 and executes DMA transfer. DMA transfer by the DMA transfer circuit 803 need not wait until the PF/ST circuit 801 completes the fetch of the plural data transfer parameters 701 in one bus access, but it is preferable that data transfer parameters 701 that have been fetched already be DMA-transferred in the order fetched. By doing this, the time taken for DMA transfer can be reduced because the DMA transfer circuit 803 can start the DMA transfer while the PF/ST circuit 801 is fetching data transfer parameters 701.

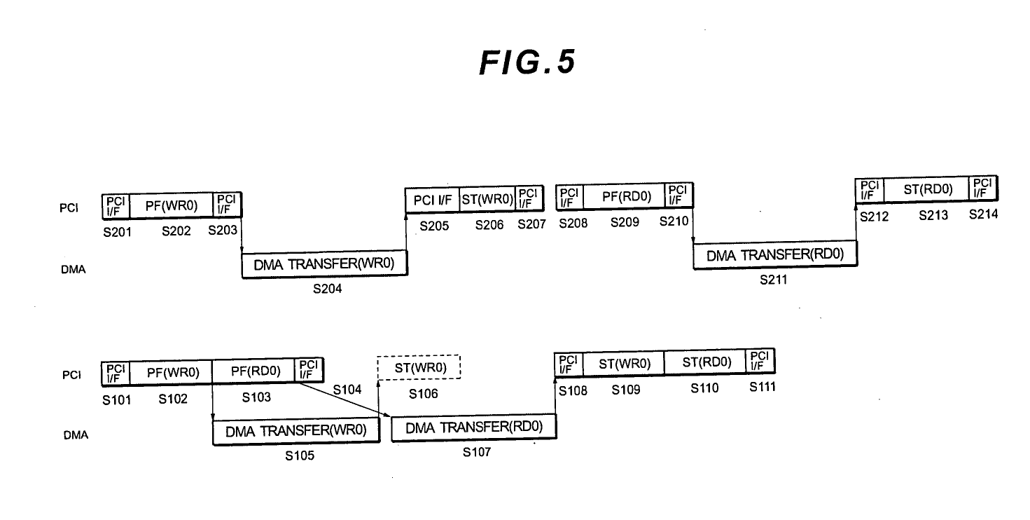

Next, a DMA cycle according to Embodiment 1 is explained with reference to FIG. 5 while comparing it with a DMA cycle in the sequential method. S101 to S111 indicate the DMA cycle according to Embodiment 1 and S202 to S214 indicate the DMA cycle in the sequential method. Here, for ease of explanation, the case where two data transfer parameters 701—a data transfer parameter (WR0) instructing DMA transfer from a host computer 200 to the cache memory 130, and a data transfer parameter (RD0) instructing DMA transfer from the cache memory 130 to the host computer 200—are stored in the local memory 113 is explained.

First, the DMA cycle according to Embodiment 1 is explained. When the PF/ST circuit 801 receives a start-up instruction from a processor 112, it goes through PCI bus arbitration (S101) and fetches a data transfer parameter (WR0) from the local memory 113 (S102). Then, it fetches a data transfer parameter (RD0) (S103), goes through PCI bus arbitration (S104), and temporarily finishes the PCI bus cycle.

The DMA transfer circuit 803 starts DMA transfer based on the data transfer parameter (WR0) (S105) when the fetch of the data transfer parameter (WR0) by the PF/ST circuit 801 is complete. Because the PF/ST circuit 801 has already started fetching the next data transfer parameter (RD0) (S103) when the DMA transfer circuit 803 starts DMA transfer, the fetch processing (S103) for the data transfer parameter (RD0) and the DMA transfer processing (105) based on the data transfer parameter (WR0) are executed simultaneously. When the DMA transfer processing (S105) based on the data transfer parameter (WR0) has finished, the DMA transfer circuit 803 generates a status (WR0) indicating DMA completion and stores it in the PF/ST storage memory 802 (S106). Moreover, when the PF/ST circuit 801 completes the fetch of the data transfer parameter (RD0), the DMA transfer circuit 803 starts DMA transfer based on the data transfer parameter (RD0) (S107).

When the DMA transfer processing (S107) based on the data transfer parameter (RD0) has finished, the PF/ST circuit 801 goes through PCI bus arbitration (S108) and stores, in the local memory 113, the status indicating completion of the DMA transfer processing based on the data transfer parameter (WR0) (S109). Then, the PF/ST circuit 801 stores, in the local memory 113, a status indicating completion of the DMA transfer processing based on the data transfer parameter (RD0) (S110), goes through PCI bus arbitration (S111), and ends the PCI bus cycle.

Next, the DMA cycle in the sequential method is explained. In this ethod, the PF/ST circuit 801 goes through PCI bus arbitration (S201), etches the data transfer parameter (WR0) (S202), goes through PCI bus arbitration, and ends the PCI bus cycle (S203). Then, the DMA transfer circuit 803 executes DMA transfer based on the data transfer parameter (WR0) (S204). When this DMA transfer has finished, the PF/ST circuit 801 again goes through PCI bus arbitration (S205), stores, in the local memory 113, a status (WR0) indicating completion of the DMA transfer based on the data transfer parameter (WR0) (S206), goes through PCI bus arbitration, and ends the PCI bus cycle (S207). For the next data transfer parameter (RD0), a DMA cycle is conducted in the same sequence as above through the fetch, the DMA transfer, and status storing (S208 to S214).

According to Embodiment 1, because a plurality of data transfer parameters are fetched and DMA-transferred in one bus access, generation of a bus neck can be solved, which is different from the sequential method where a bus access is made every time to fetch a data transfer parameter. The generation of a bus neck can also be solved by storing a plurality of statuses in the local memory. Moreover, because it is only necessary to change the design of one part of the hardware architecture of the data transfer circuit 800, expansion of the circuit size is unnecessary. Furthermore, any change in the design can be minimized because the data transfer circuit 800 in Embodiment 1 is operable with conventional micro programs.

### Embodiment 2

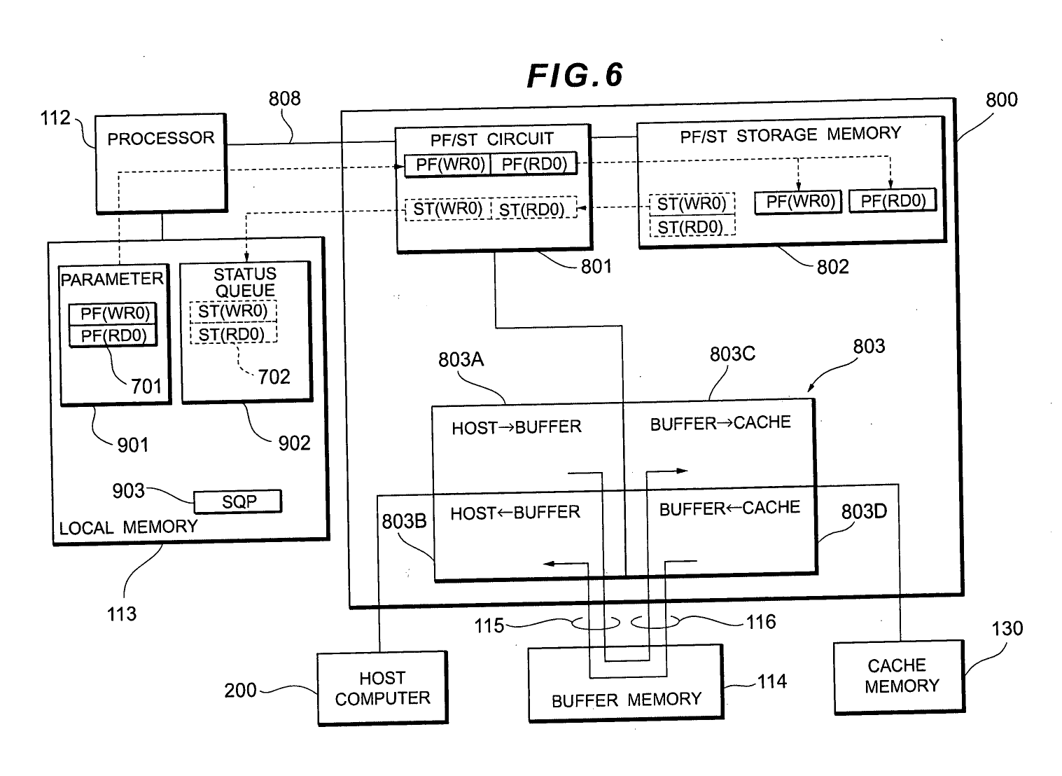

The flow of DMA transfer processing according to Embodiment 2 is described below with reference to FIG. 6. Numeral references that are the same as those in FIG. 4 indicate the same resources; therefore, detailed explanations thereof are omitted.

The DMA transfer circuit 803 has an interface 803A for conducting DMA transfer from the host computer 200 to the buffer memory 114, an interface 803C for conducting DMA transfer from the buffer memory 114 to the cache memory 130, an interface 803D for conducting DMA transfer from the cache memory 130 to the buffer memory 114, and an interface 803B for conducting DMA transfer from the buffer memory 114 to the host computer 200. The interface 803A and the interface 803C operate to DMA-transfer write data from the host computer 200 to the cache memory 130. On the other hand, the interface 803D and the interface 803B operate to DMA-transfer read data from the cache memory 130 to the host computer 200.

Because the interface 803A and the interface 803B share the bus 115 to connect to the buffer memory 114, when one of them is operating, the other cannot. That is, the interface 803A and the interface 803B operate exclusively. Likewise, the interface 803C and the interface 803D share the bus 116 to connect to the buffer memory 114; therefore, when one of them is operating, the other cannot. That is, they also operate exclusively.

However, the interface 803A and the interface 803D are connected to the buffer memory 114 via different buses, the bus 115 and the bus 116, and therefore do not interfere with each other and can operate simultaneously. Likewise, the interface 803B and the interface 803C are connected to the buffer memory 114 via different buses, the bus 115 and the bus 116, and therefore, they also do not interfere with each other and can operate simultaneously.

With the above-described structure, the DMA circuit 803 of Embodiment 2 can execute DMA transfer from the host computer 200 to the cache memory 130 and DMA transfer from the cache memory 10 to the host computer 200 at the same time. In other words, the DMA circuit 803 enables two-way data transfer.

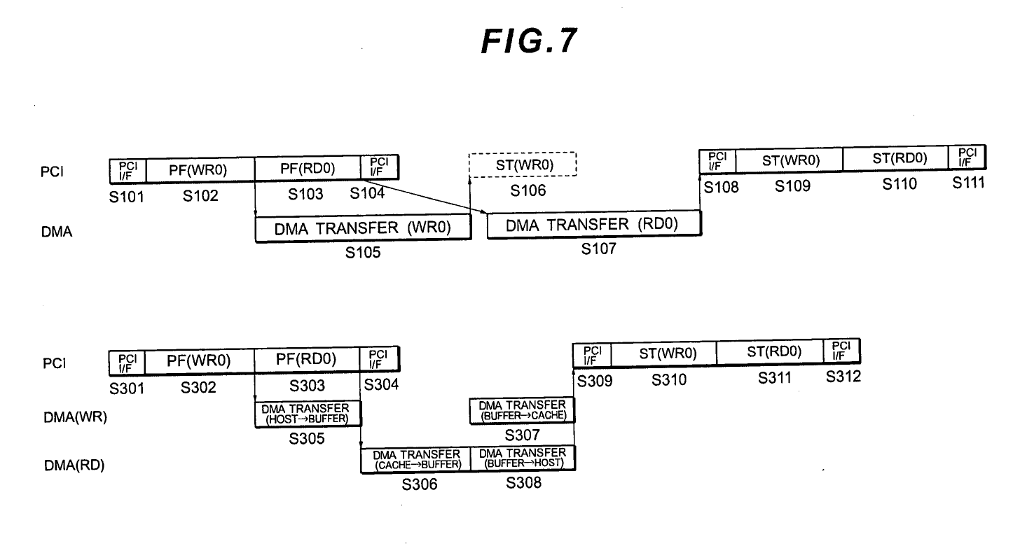

Now, with reference to FIG. 7, explanations will be given for a DMA cycle according to Embodiment 2 while comparing it with the DMA cycle according to Embodiment 1. S301 to S312 indicate the DMA cycle according to Embodiment 2 and S101 to S11 indicate the DMA cycle according to Embodiment 1. Here, for ease of explanation, explanations will be given for a case where the local memory 113 stores two data transfer parameters 701: a data transfer parameter (WR0) instructing DMA transfer from the host computer 200 to the cache memory 130; and a data transfer parameter (RD0) instructing DMA transfer from the cache memory 130 to the host computer 200.

In the DMA cycle according to Embodiment 2, when the PF/ST circuit 801 receives a start-up instruction from the processor 112, it goes through PCI bus arbitration (S301) and fetches a data transfer parameter (WR0) from the local memory 130 (S302). Then, it fetches a data transfer parameter (RD0) (S303), goes through PCI bus arbitration (S304), and temporarily finishes the PCI bus cycle. The PF/ST circuit 801 divides the data transfer parameter (WR0) and the data transfer parameter (RD0) it fetched into a write command and a read command, and stores them in the PF/ST storage memory 802.

When the PF/ST circuit 801 completes the fetch of the data transfer parameter (WR0), the DMA transfer circuit 803 has the interface 803A operate and starts DMA transfer from the host computer 200 to the buffer memory 114 (S305). As described above, because the interface 803A and the interface 803D can operate at the same time, even when the interface 803A is operating, the interface 803D can start DMA transfer from the cache memory 130 to the buffer memory 114 (S306) when the fetch of the data transfer parameter (RD0) is complete.

After that, even when the DMA transfer from the host computer 200 to the buffer memory 114 is complete, the bus 116 is occupied with the interface 803D during operation of the interface 803D, accordingly, the interface 803C cannot be operate. The interface 803C waits until the DMA transfer by the interface 803D is completed and the bus 116 released, and then starts DMA transfer from the buffer memory 114 to the cache memory 130 (S307). Likewise, because the bus 115 is occupied with the interface 803A during DMA transfer by the interface 803A, the interface 803B cannot execute DMA transfer. The interface 803B waits until DMA transfer by the interface 803A is completed and the bus 115 released, and then starts DMA transfer from the buffer memory 114 to the host computer 200 (S308).

Through the above-described sequence, when DMA transfer from the host computer 200 to the cache memory 130 (S305, S307) and the DMA transfer from the cache memory 130 to the host computer 200 (S306, S308) is complete, the PF/ST circuit 801 goes through PCI bus arbitration (S309) and stores a status (WR0) in the local memory 113 (S310). Subsequently, the PF/ST circuit 801 stores a status (RD0) in the local memory 113 (S311), oes through PCI bus arbitration (S312), and ends the PCI bus cycle.

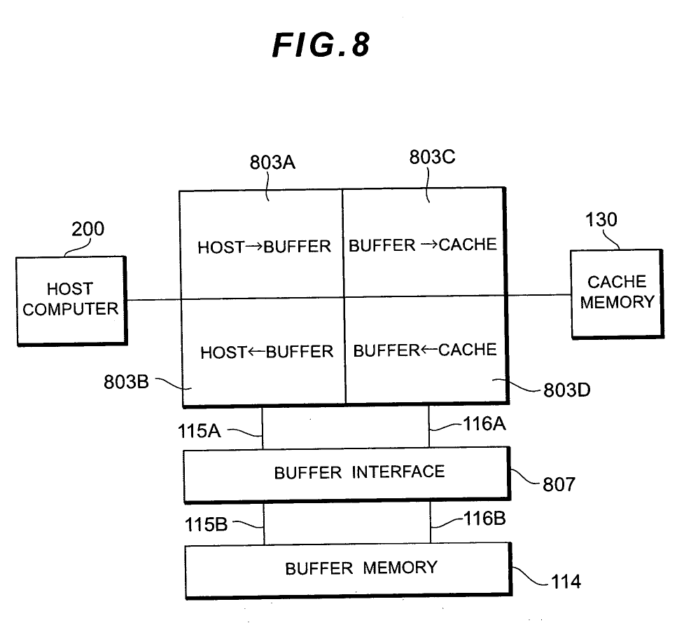

Now, explanations will be given for bus arbitration provided between the DMA transfer circuit 803 and the buffer memory 114 with reference to FIG. 8. The DMA transfer circuit 803 is connected to the buffer memory 114 via the buffer interface 807. The above-described bus 115 consists of a bus 115A and a bus 115B. The bus 115A connects the buffer interface 807 with either of the interface 803A and the interface 803B, whichever being selected exclusively by the buffer interface 807. The bus 115B connects the buffer interface 807 with the buffer memory 114. Likewise, the bus 116 consists of a bus 116A and a bus 116B. The bus 116A connects the buffer interface 807 with either of the interface 803C and the interface 803D, whichever being selected exclusively by the buffer interface 807. The bus 116B connects the buffer interface 807 with the buffer memory 114.

Now, explanations will be given for bus arbitration by the buffer interface 807 executed when the DMA transfer from the host computer 200 to the cache memory 130 and the DMA transfer from the cache memory 130 to the host computer 200 are executed at the same time. In order to DMA-transfer write data from the host computer 200 to the cache memory 130, a DMA transfer request requesting DMA transfer of the write data to the buffer memory 114 is first transmitted from the interface 803A via the bus 115A to the buffer interface 807. When this happens, because the bus 115B is free, the buffer interface 807 approves the DMA transfer request made by the interface 803A requesting DMA transfer of the write data to the buffer memory 114, and after that, the interface 803A DMA-transfers the write data from the host computer 200 to the buffer memory 114.

In order to DMA-transfer read data from the cache memory 130 to the host computer 200, a DMA transfer request requesting DMA-transfer of read data to the buffer memory 114 is first transmitted from the interface 803D via the bus 116A to the buffer interface 807. Because the bus 116B is free, the buffer interface 807 approves the DMA transfer request made by the interface 803D requesting DMA transfer of the read data to the buffer memory 114, and after that, the interface 803D DMA-transfers the read data from the cache memory 130 to the buffer memory 114.

Then, DMA transfer of the read data from the cache memory 130 to the buffer memory 114 by the interface 803D is complete. At this point in time, the bus 116A and the bus 116B are released. The DMA transfer request requesting DMA transfer of the read data to the host computer 200 is transmitted from the interface 803B to the buffer interface 807 via the bus 115A. However, at this point of time, the interface 803A is in the middle of executing DMA transfer of the write data from the host computer 200 to the buffer memory 114, so the interface 803B waits until the bus 115A and the bus 115B are released.

The bus 115A and the bus 115B are released when the interface 803A completes DMA-transferring the write data from the host computer 200 to the buffer memory 114. Accordingly, the buffer interface 807 approves the DMA transfer request made by the interface 803B requesting DMA transfer of the read data from the buffer memory 114 to the host computer 200, and after that, the interface 803B DMA-transfers the read data from the buffer memory 114 to the host computer 200.

The DMA transfer request requesting DMA transfer of the write data to the cache memory 130 is transmitted from the interface 803C to the buffer interface 807 via the bus 116A. Because the bus 116A and the bus 116B are released at this point of time, the buffer interface 807 approves the DMA transfer request made by the interface 803C requesting DMA transfer of the write data from the buffer memory 114 to the cache memory 130, and after that, the interface 803C DMA-transfers the write data from the buffer memory 114 to the cache memory 130.

Subsequently, the interface 803B completes DMA transfer of the read data from the buffer memory 114 to the host computer 200. In addition, the interface 803C completes DMA transfer of the write data from the buffer memory 114 to the cache memory 130.

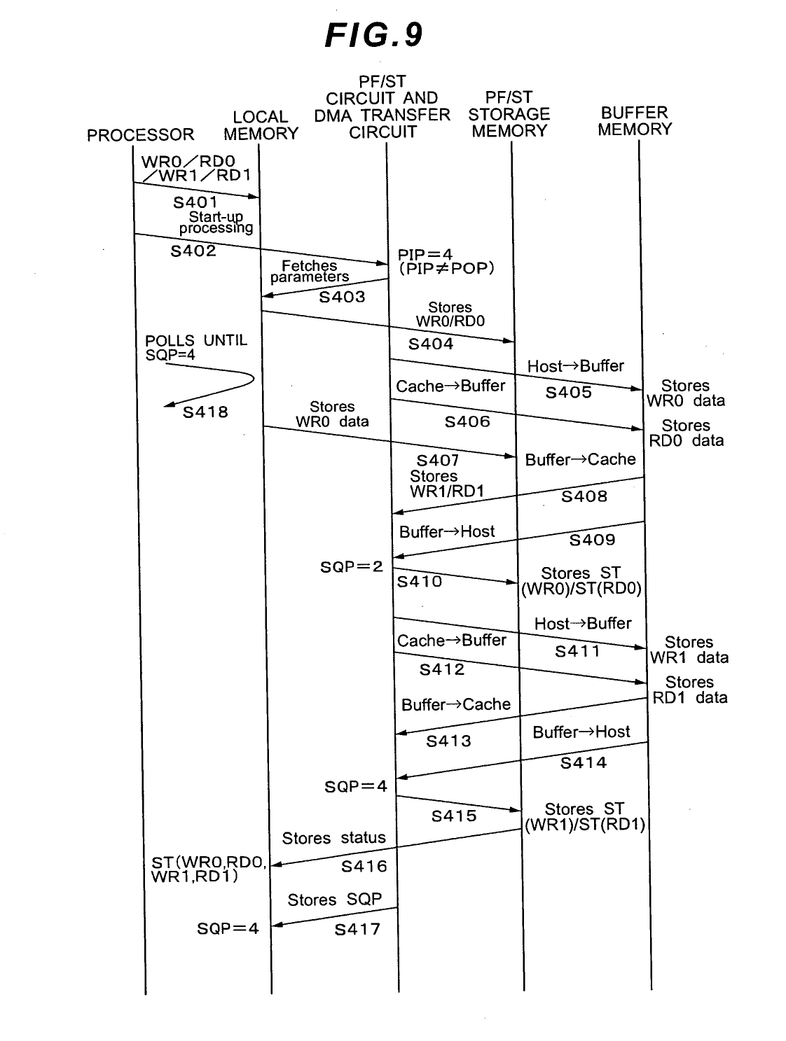

FIG. 9 shows a sequence chart for DMA transfer according to Embodiment 2. Operations of respective parts are explained below with reference to FIG. 9.

The processor 112 sets data transfer parameters (WR0/RD0/WR1/RD1) in the local memory 113 (S401), substitutes 4 for a Parameter In Pointer (PIP), and transmits a start-up instruction to the PF/ST circuit 801 (S402). The PIP is a pointer showing the number of data transfer parameters the processor 112 sets in the local memory 113.

Then, the PF/ST circuit 801 compares the PIP with a Parameter Out Pointer (POP). A POP is a pointer showing the number of data transfer parameters the PF/ST circuit 801 fetched from the local memory 113. In the initial stage of DMA transfer, POP=0, therefore, PIP≠POP. The PF/ST circuit 801 then fetches data transfer parameters (WR0/RD0) from the local memory 113 and stores them in the PF/ST storage memory 113 (S404).

Then, the DMA transfer circuit 803 starts up and DMA-transfers write data from the host computer 200 to the buffer memory 114 via the interface 803A (S405). It also DMA-transfers read data from the cache memory 130 to the buffer memory 114 via the interface 803D (S406).

The PF/ST circuit 801 fetches data transfer parameters (WR1/RD1) non-synchronously with the DMA transfer by the DMA transfer circuit 803 and stores them in the PF/ST storage memory 113 (S407).

When the DMA transfer of the write data to the buffer memory has finished, DMA transfer of the write data from the buffer memory 114 to the cache memory 130 is conducted via the interface 803C (S408). Moreover, when the DMA transfer of the read data to the buffer memory 114 has finished, DMA transfer from the buffer memory 114 to the host computer 200 is conducted via the interface 803B (S409).

When the DMA transfer based on the data transfer parameters (WR0/RD0) has finished, statuses ST (WR0)/ST (RD0) are stored in the PF/ST storage memory 802 (S410), and a Status Queue Pointer (SQP)=2. A SQP is a pointer showing the number of statuses.

Next, DMA transfer based on data transfer parameters (WR1/RD1) is started and write data is DMA-transferred from the host computer 200 to the buffer memory 114 via the interface 803A (S411). Moreover, read data is DMA-transferred from the cache memory 130 to the buffer memory 114 via the interface 803D (S412).

When the DMA transfer of the write data to the buffer memory 114 has finished, DMA transfer of the write data from the buffer memory 114 to the cache memory 130 is conducted via the interface 803C (S413). Moreover, when the DMA transfer of the read data to the buffer memory 114 has finished, DMA transfer of the read data from the buffer memory 114 to the host computer 200 is conducted via the interface 803B (S414).

When the DMA transfer based on the data transfer parameters (WR1/RD1) has finished, statuses ST (WR1)/ST (RD1) are stored in the PF/ST storage memory 802 (S415). Then, the statuses ST (WR0, RD0, WR1, RD1) are stored in the local memory 113 (S416) and SQP=4 (S417).

After setting the data transfer parameters (WR0/RD0/WR1/RD1) in the local memory 113, the processor 112 only needs to conduct periodical polling until SQP=4 (S418), therefore, it may be engaged with other task processing (for example, preparation for the next data transfer parameter, communication with other processors, fault diagnosis, etc.).

According to Embodiment 2, data transfer parameters fetched from the local memory 113 are divided into write commands and read commands and stored in the PF/ST storage memory 802, and write commands and read commands are executed at the same time in the DMA transfer circuit 803, thereby enhancing DMA transfer efficiency.

We claim:

1. A data transfer circuit for conducting DMA transfer between an input/output device and memory, the data transfer circuit comprising:
a fetch circuit for fetching, in one bus access, a plurality of data transfer parameters stored by a processor in a local memory to direct DMA transfer;
a parameter storage memory for storing the data transfer parameters fetched by the fetch circuit; and
a DMA transfer circuit for conducting DMA transfer based on the data transfer parameters stored in the parameter storage memory.

2. The data transfer circuit according to claim 1, wherein the parameter storage memory stores DMA transfer statuses for respective directions of the plurality of data transfer parameters; and the fetch circuit transfers a plurality of the statuses from the parameter storage memory to the local memory in one bus access.

3. The data transfer circuit according to claim 1, wherein the parameter storage memory divides the data transfer parameters into write commands and read commands to store; and the DMA transfer circuit executes parallel processing for the write commands and the read commands.

4. The data transfer circuit according to claim 3, wherein the DMA transfer circuit comprises a first interface for conducting DMA transfer from the input/output device to the memory and a second interface for conducting DMA transfer from the memory to the input/output device.

5. A data transfer method for conducting DMA transfer between an input/output device and a memory, the method comprising the steps of:
fetching, in one bus access, a plurality of data transfer parameters stored by a processor in a local memory to direct DMA transfer;
storing the data transfer parameters fetched in the fetching step in a parameter storage memory; and
conducting DMA transfer based on the data transfer parameters stored in the parameter storage memory.

6. The data transfer method according claim 5 further comprising the steps of:
storing DMA transfer statuses for respective directions of the plurality of data transfer parameters; and
transferring a plurality of the statuses from the parameter storage memory to the local memory in one bus access.

7. The data transfer method according to claim 5, wherein in the parameter storing step, the data transfer parameters are divided into write commands and read commands to be stored; and in the DMA transferring step, the write commands and the read commands are parallel-processed.
